(19) United States
(12) Patent Application Publication
(10) Pub. No.: US 2015/0310264 A1
(43) Pub. Date: Oct. 29, 2015

(54) Dynamic Gesture Recognition Using Features Extracted from Multiple Intervals

(71) Applicant: Avago Technologies General IP (Singapore) Pte. Ltd., Singapore (SG)

(72) Inventors: Pavel Aleksandrovich Aliseitchik, Moscow (RU); Ivan Leonidovich Mazurenko, Khimki (RU); Aleksey Alexandrovich Letunovskiy, Moscow (RU); Denis Vasilyevich Parfenov, Moscow (RU); Denis Vladimirovich Parkhomenko, Mytyschy (RU)

(21) Appl. No.: 14/676,435

(22) Filed: Apr. 1, 2015

(30) Foreign Application Priority Data
Apr. 29, 2014 (RU) 2014117521

(51) Int. Cl. G06K 9/00; G06K 9/46

(52) U.S. Cl. CPC G06K 9/00335; G06K 9/4604

(57) ABSTRACT

In one embodiment, an image processor comprises image processing circuitry and an associated memory. The image processor is configured to implement a gesture recognition system utilizing the image processing circuitry and the memory. The gesture recognition system implemented by the image processor comprises a dynamic gesture recognition module. The dynamic gesture recognition module is configured to establish a dynamic gesture recognition interval comprising a plurality of image frames, to extract one or more first features from the dynamic gesture recognition interval, to adjust the dynamic gesture recognition interval, to extract one or more second features from the adjusted dynamic gesture recognition interval, and to recognize a dynamic gesture based at least in part on at least a subset of the extracted first and second features.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processor comprises image processing circuitry and an associated memory. The image processor is configured to implement a gesture recognition system utilizing the image processing circuitry and the memory. The gesture recognition system implemented by the image processor comprises a dynamic gesture recognition module. The dynamic gesture recognition module is configured to establish a dynamic gesture recognition interval comprising a plurality of image frames, to extract one or more first features from the dynamic gesture recognition interval, to adjust the dynamic gesture recognition interval, to extract one or more second features from the adjusted dynamic gesture recognition interval, and to recognize a dynamic gesture based at least in part on at least a subset of the extracted first and second features.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor with a dynamic gesture subsystem implementing a process for recognition of dynamic gestures in an illustrative embodiment.

FIG. 2 shows a more detailed view of the dynamic gesture subsystem of the image processor of the FIG. 1 system, illustrating exemplary interaction between a dynamic gesture preprocessing detector, a dynamic gesture recognizer and other components of the dynamic gesture subsystem.

FIG. 3 illustrates exemplary trajectory features comprising negative log likelihood (NLL) plots generated for respective static hand poses over a multi-frame interval for use in recognition of a particular dynamic gesture in a case in which the trajectory features are clearly distinguishable from one another in start, middle and end portions of the interval.

FIG. 4 illustrates exemplary trajectory features comprising NLL plots generated for respective static hand poses over a multi-frame interval for use in recognition of a particular dynamic gesture in a case in which the trajectory features are not clearly distinguishable from one another in a middle portion of the interval.

FIG. 5 shows exemplary initial and adjusted dynamic gesture recognition intervals each comprising start, middle and end portions.

FIG. 6 is a flow diagram of an iterative process for extracting features from dynamic gesture recognition intervals in an illustrative embodiment.

### DETAILED DESCRIPTION

Embodiments of the invention will be illustrated herein in conjunction with exemplary image processing systems that include image processors or other types of processing devices implementing techniques for improved dynamic gesture recognition. It should be understood, however, that embodiments of the invention are more generally applicable to any image processing system or associated device or technique that involves recognizing dynamic gestures in one or more images.

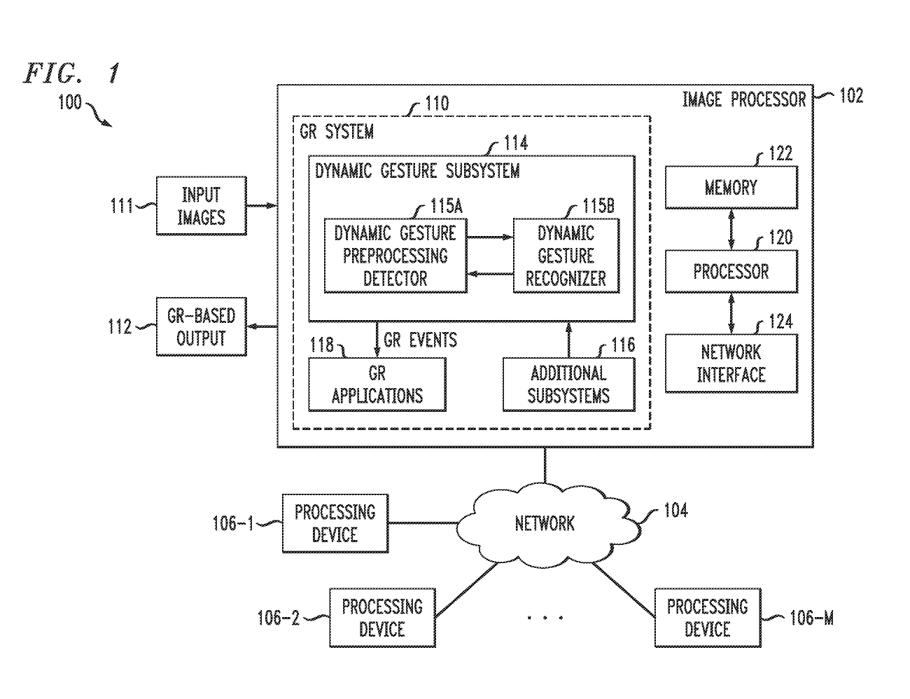

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

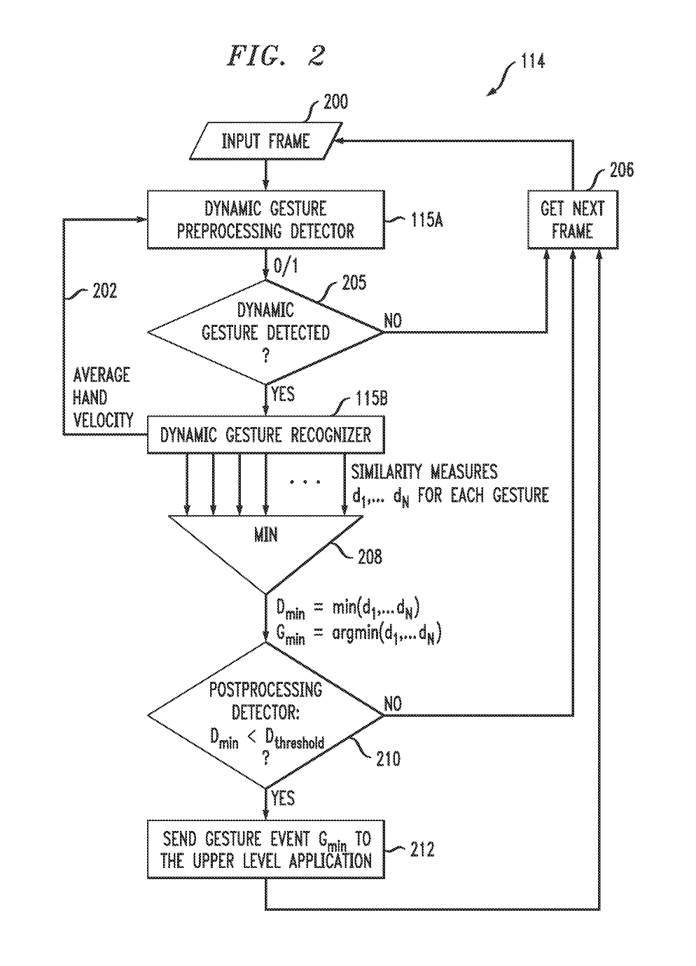

The GR system 110 more particularly comprises a dynamic gesture subsystem 114 that includes a dynamic gesture preprocessing detector 115A coupled to a dynamic gesture recognizer 115B. The GR system in the present embodiment is configured to implement a gesture recognition process in which a dynamic gesture recognition portion of the process performed in dynamic gesture recognizer 115B is selectively enabled using hand velocity determined by the preprocessing detector 115A, although such selective enabling using hand velocity may be eliminated in other embodiments. Moreover, other types of information characterizing detected hand movement may be used in addition to or in place of hand velocity in other embodiments. Accordingly, the preprocessing detector 115A can be configured to detect hand velocity or other types of hand movement, possibly based on information relating to changes in static hand features. The operation of the dynamic gesture subsystem 114 will be described in greater detail below in conjunction with FIGS. 2 through 6.

The dynamic gesture subsystem 114 receives inputs from additional subsystems 116, which may comprise one or more image processing subsystems configured to implement functional blocks associated with gesture recognition in the GR system 110, such as, for example, functional blocks for input frame acquisition, preprocessing, noise and background estimation and removal, hand detection and tracking, and static hand pose recognition. It should be understood, however, that these particular functional blocks are exemplary only, and other embodiments of the invention can be configured using other arrangements of additional or alternative functional blocks.

The dynamic gesture subsystem 114 is an example of what is more generally referred to herein as a “dynamic gesture recognition module.” Such a module is assumed to be an element of a GR system implemented using an image processor.

In the FIG. 1 embodiment, the dynamic gesture subsystem 114 generates GR events for consumption by one or more GR applications 118. For example, the GR events may comprise information indicative of recognition of one or more particular gestures within one or more frames of the input images 111, such that a given GR application can translate that information into a particular command or set of commands to be executed by that application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of the GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of hand gestures within frames of an input image stream comprising the input images 111. Such processing layers may also be implemented in the form of respective subsystems of the GR system 110.

It should be noted, however, that embodiments of the invention are not limited to recognition of dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 114 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize dynamic hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 116 and 118 of image processor 102. One possible example of image processing circuitry that may be used in one or more embodiments of the invention is an otherwise conventional graphics processor suitably reconfigured to perform functionality associated with one or more of the components 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 114 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry. In some embodiments, the memory may be at least partially incorporated within such image processing circuitry, although other associations between at least portions of a memory and corresponding image processing circuitry are contemplated.

Articles of manufacture comprising computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the image processor 102 will now be described in greater detail with reference to the diagram of FIG. 2. The diagram illustrates an exemplary implementation of the dynamic gesture subsystem 114 of the GR system 110, including the dynamic gesture preprocessing detector 115A and the dynamic gesture recognizer 115B as well as other supporting components.

It is further assumed in this embodiment that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

As illustrated in FIG. 2, a current input frame 200 is applied to the dynamic gesture preprocessing detector 115A. This detector is configured to detect movement of a hand in one or more input frames, so that a determination can be made regarding whether or not the detected movement is likely to correspond to one of a plurality of predetermined dynamic hand gestures supported by the GR system 110. The supported gestures are more denoted herein by the set G={G₁, G₂, . . . , G_{N}} where N denotes the total number of supported gestures. The set G is also referred to herein as the gesture vocabulary of the GR system 110.

As one example, the supported gestures may include a swipe left gesture, a swipe right gesture, a swipe up gesture, a swipe down gesture, a poke gesture and a wave gesture, such that the set G={swipe left, swipe right, swipe down, swipe up, poke, wave}, although various subsets of these gestures as well as additional or alternative gestures may be supported in other embodiments. Accordingly, embodiments of the invention are not limited to use with any particular gesture vocabulary.

The dynamic gesture preprocessing detector 115A estimates an absolute value or magnitude of an average hand velocity V using the input frame 200 and at least one previous frame. This determination in the present embodiment also illustratively incorporates average hand velocity information for one or more previous frames as supplied to the dynamic gesture preprocessing detector 115A by the dynamic gesture recognizer 115B via line 202. The term “average” in this context should be understood to encompass, for example, averaging of multiple velocity measures determined for respective pixels associated with a hand region of interest (ROI), although other types of averaging could be used. A given velocity measure may be determined, for example, based on movement of a particular point in the ROI between current and previous frames.

The dynamic gesture preprocessing detector 115A compares the average hand velocity V with a predefined velocity threshold Vₘᵢₙ. If the average hand velocity V is greater than or equal to the velocity threshold Vₘᵢₙ, the detector 115A returns a logic 1, and otherwise returns a logic 0. The velocity threshold Vₘᵢₙ will vary depending upon the type of gestures supported by the GR system, but exemplary Vₘᵢₙ values for the set G of dynamic hand gestures mentioned above are on the order of about 0.5 to 1.0 meters per second.

By way of example, the average hand velocity may comprise hand velocity coordinates Vx, Vy and Vz and the magnitude of the velocity may be determined as V=sqrt(Vx̂2+Vŷ2+Vẑ2), although other velocity measures may be used in other embodiments. Also, as indicated previously, other types of detected hand movement may be used, including movement detected based on changes in static hand features. The above-noted velocity coordinates Vx, Vy and Vz may be viewed as one example of movement information derived from changes in static hand features, and numerous other types of movement information derived from static hand features may be used in other embodiments.

A decision block 205 utilizes the binary output of the dynamic gesture preprocessing detector 115A to determine if a dynamic gesture is detected in the input frame 200. For a value of 0 from the detector 115A, the decision block indicates that no dynamic gesture is detected and the process moves to block 206 to get the next frame. For a value of 1 from the detector 115A, the decision block indicates that a dynamic gesture is detected, and the process moves to the dynamic gesture recognizer 115B. The dynamic gesture recognizer 115B is also assumed to receive the input frame 200, although this connection is not explicitly shown in the simplified diagram of FIG. 2. The decision block 205 in other embodiments may be incorporated into the detector 115A, rather than implemented outside of detector 115A as in the FIG. 2 embodiment.

The dynamic gesture recognizer 115B generates similarity measures d₁, d₂, . . . d_{N} for respective ones of the gestures G₁, G₂, . . . , G_{N}. By way of example, the similarity measures may be based on respective probabilities or probability densities {Pᵢ, i=1 . . . N} each indicating the likelihood of the detected hand movement corresponding to a particular gesture in G. As a more particular example, similarity measures may be defined as dᵢ=−log(Pᵢ), in which case the similarity measures comprise respective negative log likelihoods (NLLs) of a statistical classifier. Although some embodiments disclosed herein utilize NLLs, other types of similarity measures may be used in other embodiments. Also, the embodiments that utilize NLLs can be reconfigured in a straightforward manner to utilize other types of similarity measures.

The similarity measures generated by the dynamic gesture recognizer 115B are applied to a minimum determining element 208 which determines Dₘᵢₙ=min(d₁, d₂, . . . d_{N}) as the minimum of the similarity measures d₁, d₂, . . . d_{N}, and identifies Gₘᵢₙ=argmin(d₁, d₂, . . . d_{N}) as the particular gesture for which the minimum similarity measure Dₘᵢₙ was achieved. The minimum determining element 208 is an example of what is more generally referred to herein as a “selection element,” and in other embodiments other types of selection elements may be used. For example, use of certain types of similarity measures may necessitate use of a maximization function rather than a minimization function in the selection element.

A postprocessing detector is implemented in decision block 210 to determine if Dₘᵢₙ is below a specified gesture recognition threshold D_{threshold}. If Dₘᵢₙ is not below the threshold, a dynamic gesture is not recognized in the current frame and the process moves to block 206 to obtain the next frame. If Dₘᵢₙ is below the threshold, a GR event is generated indicating that gesture Gₘᵢₙ has been recognized in the current frame, and the GR event is sent to an upper level application, illustratively one of the GR applications 118, as indicated in block 212. The postprocessing detector in decision block 210 is generally configured to reject out-of-vocabulary hand movements. In some embodiments, the threshold D_{threshold} is set to infinity or to an arbitrary large value so that no dynamic gestures recognized by the dynamic gesture recognizer 115B are rejected. The threshold D_{threshold} is an example of what is more generally referred to herein as a distance threshold.

After generation of the GR event in block 212, the process returns to step 206 to get the next frame. The above-described processing is then repeated with the next frame serving as the current input frame.

Additional details regarding illustrative embodiments of the dynamic gesture recognizer 115B can be found in PCT International Application No. PCT/US14/34586, filed Apr. 18, 2014 and entitled “Dynamic Hand Gesture Recognition with Selective Enabling Based on Detected Hand Velocity,” which is commonly assigned herewith and incorporated by reference herein.

By way of example, in one such embodiment, the recognizer 115B uses the above-noted exemplary gesture vocabulary G={swipe left, swipe right, swipe down, swipe up, poke, wave}, and thus N=6 and the recognizer 115B generates six output similarity measures d₁, d₂, . . . d₆ for respective ones of the six supported gestures.

Again, other gesture vocabularies can be used in other embodiments, and the configuration of the dynamic gesture recognizer 115B adjusted accordingly. For example, another static hand pose vocabulary can include static gestures denoted finger, palm with fingers, palm without fingers, hand edge, pinch, first and fingergun, and a corresponding dynamic gesture vocabulary can include dynamic gestures denoted fingerpoint, poke, swipe left, swipe right, swipe up, swipe down, zoom on, zoom off and fingergun. Many other arrangements of these and other static and dynamic gestures are possible.

The dynamic gesture recognizer 115B is further assumed to include a history buffer and a static hand pose estimator.

The history buffer of the dynamic gesture recognizer 115B stores data from previous frames. The history buffer may be implemented as a circular array of a fixed size so that writing new data to the buffer automatically erases a buffer tail corresponding to the oldest data in the buffer. The history buffer is illustratively implemented utilizing a designated portion of the memory 122 of the image processor 102.

The static hand pose estimator of the dynamic gesture recognizer 115B is illustratively configured using the following process:

1. Analyze the gesture vocabulary G in terms of typical static hand poses while a user performs each gesture and split G into non-intersecting non-empty subsets of gestures G=G¹ U G² U . . . U G^{K} where K<=N and each set Gⁱ unites different dynamic gestures where typical hand shape is the same or non-distinguishable. For example, if G={swipe left, swipe right, swipe down, swipe up, poke, wave}, the following subsets can be used: G¹={swipe left, swipe right}, G²={swipe down, swipe up, wave}, G³={poke}. In this example, the number of gesture classes K is equal to 3.

2. Collect sample recordings for each gesture from G for different users, recording conditions and other use cases.

3. Train K classifiers to recognize the hand poses from respective ones of the gesture classes G¹, G², . . . , G^{K}. The i-th classifier should be trained using sample recordings for all gestures from class Gⁱ. For example, to train the classifier for class G²={swipe down, swipe up, wave}, recordings for all three gestures in the class should be combined in one training set. Any of a variety of different classification techniques, including Nearest Neighbor, Gaussian Mixture Models (GMMs), Decision Trees, and Neural Networks may be used for these classifiers. Other static hand pose recognition processes may also be used.

The static hand pose estimator is further configured to return similarity measures s₁, s₂, . . . s_{K} from respective ones of the K classifiers for each image frame. By way of example, the similarity measures sᵢ may correspond to NLLs if GMMs are used to classify the static hand poses. The similarity measures s₁, s₂, . . . s_{K} are used by detectors in the dynamic gesture recognizer 115B and are also saved in the history buffer for further processing.

In the present embodiment, the dynamic gesture recognizer 115B more particularly utilizes trajectory features extracted from multiple intervals with each such interval comprising a potentially different arrangement of image frames, as will now be described with reference to FIGS. 3 through 6.

Referring initially to FIG. 3, exemplary trajectory features extracted from a given interval for respective ones of two different static hand poses are shown. The trajectory features in this example include trajectory features 300 and 302 extracted for respective “pinch” and “open palm” static hand poses used to detect a “zoom on” dynamic gesture. Each of the trajectory features 300 and 302 comprises a plot of similarity measures generated by a corresponding one of the above-noted static hand pose classifiers over the multiple frames of a dynamic gesture detection interval. More particularly, in generating a given trajectory feature for an interval, a similarity measure is generated for each frame by the corresponding static hand pose classifier, and the trajectory feature characterizes the variation in the similarity measure over the multiple frames of the interval. The similarity measure illustratively comprises an NLL as previously described. The trajectory features 300 and 302 may therefore be viewed as showing variations in respective NLLs over time for the multiple frames of the interval. Each of the trajectory features in the FIG. 3 example is more particularly plotted as NLL values on the y-axis of the plot as a function of time in seconds on the x-axis of the plot.

In the FIG. 3 example, the trajectory features 300 and 302 generated for respective pinch and open palm static hand poses over a multi-frame interval are clearly distinguishable from one another in start, middle and end portions of the interval. Accordingly, the zoom dynamic gesture can be readily recognized in this example by threshold-based detection of the pinch static hand pose in a start portion of the interval and the open palm static hand pose in an end portion of the interval.

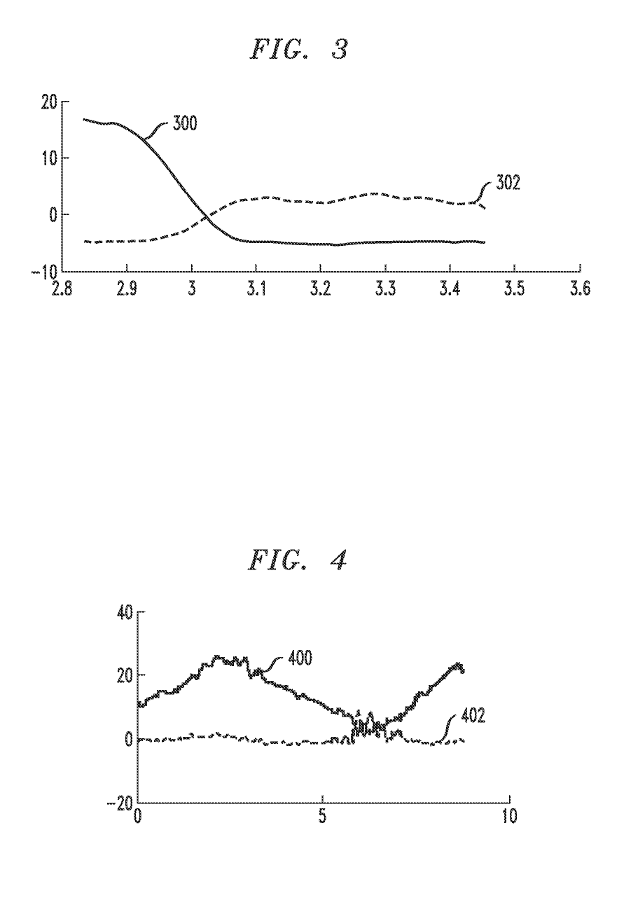

FIG. 4 shows another example of trajectory features extracted from a given interval for respective ones of two different static hand poses. The trajectory features in this example include trajectory features 400 and 402 extracted for respective “fingergun” and “finger” static hand poses used to detect a “fingergun” dynamic gesture.

As in the FIG. 3 example, each of the trajectory features 400 and 402 comprises a plot of similarity measures generated by a corresponding one of the above-noted static hand pose classifiers over the multiple frames of a dynamic gesture detection interval. As previously described, in generating a given trajectory feature for an interval, a similarity measure is generated for each frame by the corresponding static hand pose classifier, and the trajectory feature characterizes the variation in the similarity measure over the multiple frames of the interval. The similarity measure illustratively comprises an NLL as previously described. The trajectory features 400 and 402, like the trajectory features 300 and 302 of FIG. 3, may be viewed as showing variations in respective NLLs over time for the multiple frames of the interval. Accordingly, each of the trajectory features in the FIG. 4 example, like those in the FIG. 3 example, is more particularly plotted as NLL values on the y-axis of the plot as a function of time in seconds on the x-axis of the plot.

In the FIG. 4 example, the trajectory features 400 and 402 generated for respective fingergun and finger static hand poses over a multi-frame interval are not clearly distinguishable from one another in a middle portion of the interval. For example, averaging the similarity measures for each of these static hand poses over the frames of the middle portion produces a similar result. Accordingly, the fingergun dynamic gesture cannot be readily recognized in this example by threshold-based detection of the two static hand poses.

The present embodiment overcomes dynamic gesture recognition issues such as that presented by the FIG. 4 example, at least in part by extracting features from different multi-frame intervals. For example, an initial dynamic gesture recognition interval comprising multiple frames is established, and one or more first features are extracted from the initial dynamic gesture recognition interval. The dynamic gesture recognition interval is then adjusted, and one or more second features are extracted from the adjusted dynamic gesture recognition interval. This interval adjustment and feature extraction may be repeated for one or more additional iterations to obtain at each such additional iteration one or more additional features for respective adjusted intervals. At least a subset of the extracted first, second and additional features are utilized in recognizing a dynamic gesture. For example, a final set of extracted features associated with a final adjusted interval can be used to recognize the dynamic gesture. Alternatively, different sets of extracted features associated with respective different intervals can be collectively used to recognize the dynamic gesture. Accordingly, various combinations of extracted features from one or more intervals can be used in dynamic gesture recognition.

The extracted features illustratively comprise trajectory features of the type previously described in conjunction with the examples of FIGS. 3 and 4. A given such trajectory feature is extracted over the multiple frames of one of the intervals, and possibly includes an NLL or other similarity measure for each of the frames of that interval. Such similarity measures are examples of respective static features and are computed for respective frames of the interval. The trajectory features used in detecting a particular dynamic gesture illustratively comprise respective sets of similarity measures generated for respective static hand pose classes associated with that particular dynamic gesture, as in the examples of FIGS. 3 and 4.

Additional details regarding exemplary techniques for estimating static features for respective image frames can be found in Russian Patent Application No. 2013148582, filed Oct. 30, 2013 and entitled “Image Processor Comprising Gesture Recognition System with Computationally-Efficient Static Hand Pose Recognition,” which is commonly assigned herewith and incorporated by reference herein.

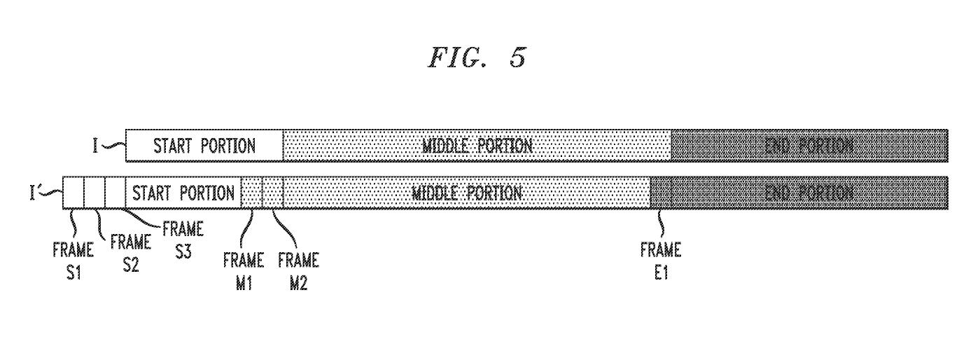

FIG. 5 shows exemplary initial and adjusted dynamic gesture recognition intervals each comprising start, middle and end portions. The initial dynamic gesture recognition in this embodiment is denoted I, and the adjusted dynamic gesture recognition interval is denoted I′, where the adjusted interval I′ has three additional frames S1, S2, S3 in its start portion that are not part of the initial interval I. Also, each of the start, middle and end portions of I′ is one frame longer than the corresponding portion of I. As shown in the figure, frames M1 and M2 in the middle portion of I′ are in the start portion of I, and frame E1 in the end portion of I′ is in the middle portion of I.

This is an example of an arrangement in which an initial dynamic gesture recognition interval is established having an interval length corresponding to a designated number of frames, and adjusting the dynamic gesture recognition interval comprises changing the interval length to include more than the designated number of frames. More particularly, adjusting the dynamic gesture recognition interval in this example comprises increasing interval length by incorporating one or more additional frames that are not in the initial dynamic gesture recognition interval into the start portion of the adjusted dynamic gesture recognition interval.

Also, in this example, each of the start, middle and end portions of the initial dynamic gesture recognition interval includes a different number of frames than the corresponding portion of the adjusted dynamic gesture recognition interval. Accordingly, adjusting the dynamic gesture recognition interval comprises reclassifying at least one frame such that it is part of a different one of the start, middle and end portions in the adjusted dynamic gesture recognition interval than in the initial dynamic gesture recognition interval. The frames that are reclassified in this example from the initial interval to the adjusted interval are the frames M1, M2 and E1, as indicated previously.

In the FIG. 5 embodiment, the initial interval may be viewed as having length N, separated into start, middle and end portions of equal lengths of N/3, although the figure is not drawn to that scale. The length N′ of the adjusted interval I′ is given by N+3, with each portion of I′ being one frame longer than its corresponding portion in the initial interval I.

It should be understood that the particular types of interval adjustments described above and shown in FIG. 5 are presented by way of illustrative example only. Numerous other types of interval adjustments can be used in other embodiments. Also, numerous other separations of a given interval into portions are possible. For example, a dynamic gesture recognition interval in other embodiments may be separated into more or fewer than the three portions used in the FIG. 5 embodiment.

In some embodiments, an extracted feature comprises one or more averages or other predetermined functions computed over a set of similarity measures or other static features determined for respective frames of the corresponding interval. Thus, for example, an extracted feature can comprise an average computed over a set of similarity measures illustrated by one of the plots in FIG. 3 or 4. As a more particular example, a given extracted feature can comprise averages f_{S}, f_{M} and f_{E} computed for respective start, middle and end portions of the corresponding interval.

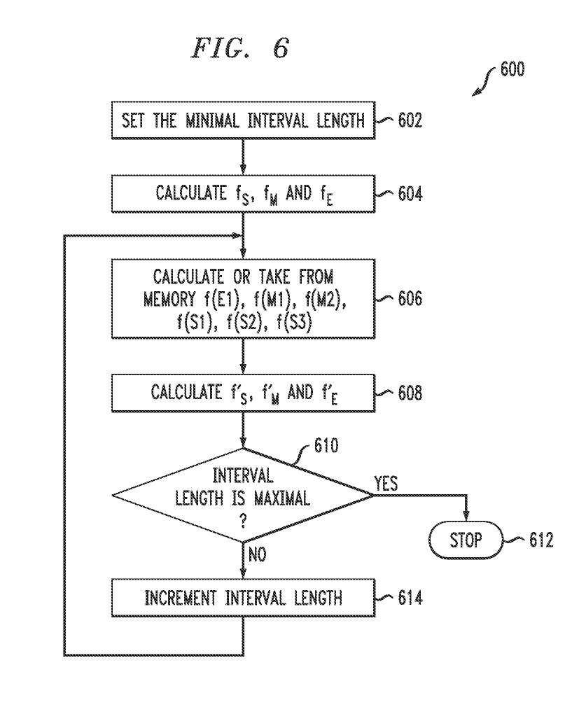

FIG. 6 shows a computationally-efficient iterative process 600 for computing extracted features as one or more averages over corresponding intervals of the type previously described in conjunction with FIG. 5. The process 600 includes steps 602 through 614 as shown and is assumed to be implemented within the dynamic gesture recognizer 115B of the dynamic gesture subsystem 114.

In step 602, a minimal interval length is set for a first iteration of the process. The corresponding interval is an example of what is more generally referred to herein as an initial dynamic gesture recognition interval. Accordingly, step 602 may be viewed as an example of what is more generally referred to herein as “establishing” an initial dynamic gesture recognition interval. In this embodiment, the initial dynamic gesture recognition interval is an interval having a specified minimum length, although in other embodiments the initial interval length can be established at a value greater than the minimal interval length. The minimum interval length is assumed to correspond to a designated number of frames, such as the number of frames of the initial interval I in FIG. 5. Interval lengths for dynamic gestures may be measured, for example, in seconds.

In step 604, the above-noted averages f_{S}, f_{M} and f_{E} are computed for the respective start, middle and end portions of the initial dynamic gesture recognition interval. As mentioned previously, such averages collectively comprise an example of an extracted feature of the initial dynamic gesture recognition interval. More particularly, the extracted feature is a type of trajectory feature.

In step 606, the interval is adjusted by including additional frames S1, S2 and S3 and reclassifying frames M1, M2 and E1 to produce adjusted dynamic gesture recognition interval I′ as previously described. In the present embodiment, this illustratively involves calculating or taking from memory the static features f(E1), f(M1), f(M2), f(S1), f(S2) and f(S3), where f(X) denotes the static feature value for frame X. This embodiment may be further configured such that the end frame of the end portion of each interval, corresponding to the right-most frame in FIG. 5, is always the last frame received from the image sensor, in order to minimize the latency of the dynamic gesture recognition process.

In step 608, a feature is extracted from the adjusted interval I′ by computing averages f′_{S}, f′_{M} and f′_{E} for the respective start, middle and end portions of the adjusted interval in accordance with the following equations:

f′_{E}=(f_{E}*N_{E}+f(E1))/(N_{E}+1);

f′_{M}=(f_{M}*N_{M}−f(E1)+f(M1)+f(M2))/(N_{M}+1);

f′_{E}=(f_{S}*N_{S}−f(M1)−f(M2)+f(S1)+f(S2)+f(S3))/(N_{S}+1).

As noted above, f_{S}, f_{M} and f_{E} denote the averages computed for the respective start, middle and end portions of the initial interval I, and f′_{S}, f′_{M} and f′_{E} denote the averages computed for the respective start, middle and end portions of the adjusted interval I′. Also, N_{S}, N_{M} and N_{E} denote the respective lengths in numbers of frames of the start, middle and end portions of the initial interval I.

In step 610, a determination is made as to whether or not the current interval length associated with the adjusted interval determined in step 606 is maximal. Accordingly, the interval length in this embodiment varies between predetermined minimal and maximal values, corresponding to the shortest and longest possible dynamic gestures, respectively. If the current interval length is maximal, for example, corresponds to a specified maximum frame length in terms of a maximum number of frames, the process ends in step 612 as indicated.

Otherwise, the interval length is incremented in step 614, and the process returns to step 606 for another iteration of interval adjustment and feature extraction. Each increment in interval length may involve, for example, adding another three frames to the start portion of the interval as illustrated for adjusted interval I′ in FIG. 5. In other embodiments, interval adjustments may involve the additional of more or fewer than three frames. For example, in an embodiment in which the initial interval has length N, with N_{S}=N_{E}=N/4 and N_{M}=N/2, the length N′ of the adjusted interval I′ may be given by N+4 rather than N+3, with N′_{S}=N′_{E}=N_{S}+1 and N′_{M}=N_{M}+2.

Numerous other types of adjustment are possible. As an example of one such alternative type of adjustment, an interval may be adjusted by altering the manner in which it is separated into start, middle and end portions without changing the interval length. Accordingly, terms such as “adjusting” and “adjusted” in the context of a dynamic gesture recognition interval need not involve changing the interval length, but can instead involve, for example, changing the number of frames in each of two or more portions of an interval.

The trajectory features determined in the manner described above are utilized by the dynamic gesture recognizer 115B in recognizing dynamic gestures. In some embodiments, the dynamic gesture recognizer implements an expectation maximization algorithm based on the extracted trajectory features to recognize the dynamic gesture. Other recognition techniques can also be used.

The particular types and arrangements of processing blocks shown in the embodiments of FIGS. 2 and 6 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments are not only able to detect hand gestures in which the hand is moving rapidly, but can also detect hand gestures in which the hand is moving slowly or not moving at all. Accordingly, a wide array of different hand gestures can be efficiently and accurately recognized. Also, the rate of false positives and other gesture recognition error rates are substantially reduced. Moreover, feature computation can be implemented using only limited processor and memory resources, and recognition issues such as that illustrated in conjunction with FIG. 4 are avoided. For example, the illustrative embodiments advantageously avoid the excessive computational complexity associated with conventional approaches that require the building of a 3D hand model. Also, some embodiments can be configured to operate in substantially real time at typical frame rates, unlike conventional gesture recognition approaches based on, for example, Hidden Markov Models (HMMs).

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
establishing a dynamic gesture recognition interval comprising a plurality of image frames;
extracting one or more first features from the dynamic gesture recognition interval;
adjusting the dynamic gesture recognition interval;
extracting one or more second features from the adjusted dynamic gesture recognition interval; and
recognizing a dynamic gesture based at least in part on at least a subset of the extracted first and second features;
wherein the establishing, extracting first features, adjusting, extracting second features and recognizing are implemented in an image processor comprising a processor coupled to a memory.

2. The method of claim 1 further comprising repeating interval adjustment and feature extraction for one or more additional iterations to obtain at each such additional iteration one or more additional features for respective adjusted intervals and wherein at least a subset of the one or more additional features are utilized in recognizing the dynamic gesture.

3. The method of claim 1 wherein establishing a dynamic gesture recognition interval comprises establishing an initial dynamic gesture recognition interval having an interval length corresponding to a designated number of the image frames.

4. The method of claim 3 wherein adjusting the dynamic gesture recognition interval comprises changing the interval length to include more or fewer than the designated number of image frames.

5. The method of claim 3 wherein each of the initial and adjusted dynamic gesture recognition intervals comprises respective start, middle and end portions.

6. The method of claim 5 wherein at least one of the start, middle and end portions of the initial dynamic gesture recognition interval includes a different number of image frames than the corresponding portion of the adjusted dynamic gesture recognition interval.

7. The method of claim 5 wherein adjusting the dynamic gesture recognition interval comprises increasing interval length by incorporating one or more additional image frames that are not in the initial dynamic gesture recognition interval into the start portion of the adjusted dynamic gesture recognition interval.

8. The method of claim 5 wherein adjusting the dynamic gesture recognition interval comprises reclassifying at least one image frame such that it is part of a different one of the start, middle and end portions in the adjusted dynamic gesture recognition interval than in the initial dynamic gesture recognition interval.

9. The method of claim 1 wherein the first and second features comprise respective trajectory features extracted over multiple frames of respective ones of the initial and adjusted dynamic gesture recognition intervals.

10. The method of claim 9 wherein a given one of the trajectory features comprises a plurality of static features computed for respective frames of the interval.

11. The method of claim 1 wherein recognizing a dynamic gesture based at least in part on at least a subset of the extracted first and second features comprises utilizing an expectation maximization algorithm to recognize the dynamic gesture.

12. The method of claim 1 wherein a given one of the first and second features utilized for recognition of a particular dynamic gesture comprises sets of similarity measures generated for respective static hand pose classes associated with that particular dynamic gesture.

13. The method of claim 12 wherein the similarity measures comprise respective negative log likelihoods.

14. An apparatus comprising:
an image processor comprising image processing circuitry and an associated memory;
wherein the image processor is configured to implement a gesture recognition system utilizing the image processing circuitry and the memory, the gesture recognition system comprising a dynamic gesture recognition module;
wherein the dynamic gesture recognition module is configured:
to establish a dynamic gesture recognition interval comprising a plurality of image frames;
to extract one or more first features from the initial dynamic gesture recognition interval;
to adjust the dynamic gesture recognition interval;
to extract one or more second features from the adjusted dynamic gesture recognition interval; and
to recognize a dynamic gesture based at least in part on at least a subset of the extracted first and second features.

15. The apparatus of claim 14 wherein the dynamic gesture recognition module comprises:
a dynamic gesture preprocessing detector; and
a dynamic gesture recognizer coupled to the dynamic gesture preprocessing detector.

16. The apparatus of claim 14 wherein the dynamic gesture recognition module is configured to establish a dynamic gesture recognition interval comprising a plurality of image frames by:
establishing an initial dynamic gesture recognition interval having an interval length corresponding to a designated number of the image frames.

17. The apparatus of claim 14 wherein the dynamic gesture recognition module is configured to adjust the dynamic gesture recognition interval by:
changing the interval length to include more or fewer than the designated number of image frames.

18. The apparatus of claim 14 wherein the first and second features comprise respective trajectory features extracted over multiple frames of respective ones of the initial and adjusted dynamic gesture recognition intervals.

19. The apparatus of claim 14 wherein a given one of the first and second features utilized for recognition of a particular dynamic gesture comprises sets of similarity measures generated for respective static hand pose classes associated with that particular dynamic gesture.

20. The apparatus of claim 19 wherein the similarity measures comprise respective negative log likelihoods.
